(19) United States
(12) Patent Application Publication
(10) Pub. No.: US 2021/0326701 A1
(43) Pub. Date: Oct. 21, 2021

(54) ARCHITECTURE FOR MACHINE LEARNING (ML) ASSISTED COMMUNICATIONS NETWORKS

(71) Applicant: QUALCOMM Incorporated, San Diego, CA (US)

(72) Inventors: Tianyang BAI, Somerville, NJ (US); Junyi LI, Franklin Park, NJ (US); Hua WANG, Basking Ridge, NJ (US); Jung Ho RYU, Fort Lee, NJ (US)

(21) Appl. No.: 17/214,583

(22) Filed: Mar. 26, 2021

Related U.S. Application Data
(60) Provisional application No. 63/011,223, filed on Apr. 16, 2020.

(51) Int. Cl. G06N 3/08; H04W 24/08; H04W 24/10; H04W 28/10; G06N 3/04

(52) U.S. Cl. CPC G06N 3/08; H04W 24/08; G06N 3/04; H04W 28/10; H04W 24/10

(57) ABSTRACT

An apparatus for wireless communications has a first component and a second component. The first component is within an application layer and configured to control machine learning modules in different nodes. The second component is within the application layer and configured to control data flow between the different nodes. A method of wireless communications, by a first node, comprises collecting measurements related to wireless communications and transmitting the measurements to a second node for machine learning processing. The method also includes transmitting the measurements to a third node for neural network training. A method by a user equipment (UE) includes reporting a UE capability to a server, and configuring neural network parameters in response to server feedback. The method further includes executing a neural network with the configured neural network parameters to determine a wireless communications analysis, and reporting the analysis to the server.

### CROSS-REFERENCE TO RELATED APPLICATION

The present application claims the benefit of U.S. Provisional Patent Application No. 63/011,223, filed on Apr. 16, 2020, and titled “ARCHITECTURE FOR MACHINE LEARNING (ML) ASSISTED COMMUNICATIONS NETWORKS,” the disclosure of which is expressly incorporated by reference in its entirety.

### FIELD OF THE DISCLOSURE

Aspects of the present disclosure generally relate to wireless communications, and more particularly to an architecture for machine learning (ML) assisted communications networks.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP).

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunications standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

Artificial neural networks may comprise interconnected groups of artificial neurons (e.g., neuron models). The artificial neural network may be a computational device or represented as a method to be performed by a computational device. Convolutional neural networks, such as deep convolutional neural networks, are a type of feed-forward artificial neural network. Convolutional neural networks may include layers of neurons that may be configured in a tiled receptive field. It would be desirable to apply neural network processing to wireless communications to achieve greater efficiencies.

### SUMMARY

Aspects of the present disclosure are directed to an apparatus for wireless communications. The apparatus has a first component within an application layer of a communication protocol stack. The first component is configured to control machine learning modules in different nodes. The apparatus also has a second component within the application layer and configured to control data flow between the different nodes.

In other aspects of the present disclosure, a method of wireless communications by a first node includes collecting measurements related to wireless communications. The method further includes transmitting the measurements to a second node for machine learning processing. The method still further includes transmitting the measurements to a third node for neural network training.

In still other aspects of the present disclosure, a method of wireless communications by a first node includes receiving measurements related to wireless communications from a second node. The method further includes processing the measurements as input to a neural network. The method still further includes forwarding output of the neural network to a module for processing. The method also includes receiving updates to the neural network from a third node.

In another aspect of the present disclosure, a method of wireless communications by a user equipment (UE) includes reporting a UE capability to a server. The method further includes configuring neural network parameters in response to feedback from the server. The method still further includes executing a neural network with the configured neural network parameters to determine a wireless communications analysis. The method also includes reporting the wireless communications analysis to the server.

Another aspect of the present disclosure is directed to an apparatus for wireless communications including means for controlling a plurality of machine learning modules in different nodes. The apparatus further includes means for controlling data flow between the different nodes.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 illustrates an example implementation of designing a neural network using a system-on-a-chip (SOC), including a general-purpose processor, in accordance with certain aspects of the present disclosure.

FIGS. 4A, 4B, and 4C are diagrams illustrating a neural network, in accordance with aspects of the present disclosure.

FIG. 4D is a diagram illustrating an exemplary deep convolutional network (DCN), in accordance with aspects of the present disclosure.

FIG. 5 is a block diagram illustrating an exemplary deep convolutional network (DCN), in accordance with aspects of the present disclosure.

FIG. 6 is a diagram illustrating an example distributed architecture for controlling machine learning modules, in accordance with various aspects of the present disclosure.

FIG. 7 is a diagram illustrating example regions associated with machine learning modules, in accordance with various aspects of the present disclosure.

FIGS. 8 and 9 are diagrams illustrating example processes performed, for example, by a first node, in accordance with various aspects of the present disclosure.

FIG. 10 is a diagram illustrating an example process performed, for example, by a user equipment (UE), in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Machine learning (ML) algorithms can assist with and improve cellular network performance. Machine learning algorithms, including a neural network based algorithm, may be implemented at a single node, such as a user equipment (UE), base station (e.g., next generation node-B (gNB)), or a central node, such as the network controller. Machine learning algorithms may also be implemented at a central server, such as a third party server. Machine learning algorithms may be distributed over multiple nodes. Machine learning algorithms may exist in different layers of a single node or across nodes.

Machine learning may be applied at different nodes for different functions with a variety of data flows. According to aspects of the present disclosure, an architecture is specified to handle various machine learning modules and the data that is transferred between nodes and layers in wireless networks. A software component (or components) in the application layer of a communication protocol stack may control various machine learning modules and data flows. The software may be distributed among UEs, base stations, central nodes, and online servers. In some aspects, the software controls multiple machine learning modules in a node. In other aspects, the software controls data transfer flow between different layers and different nodes.

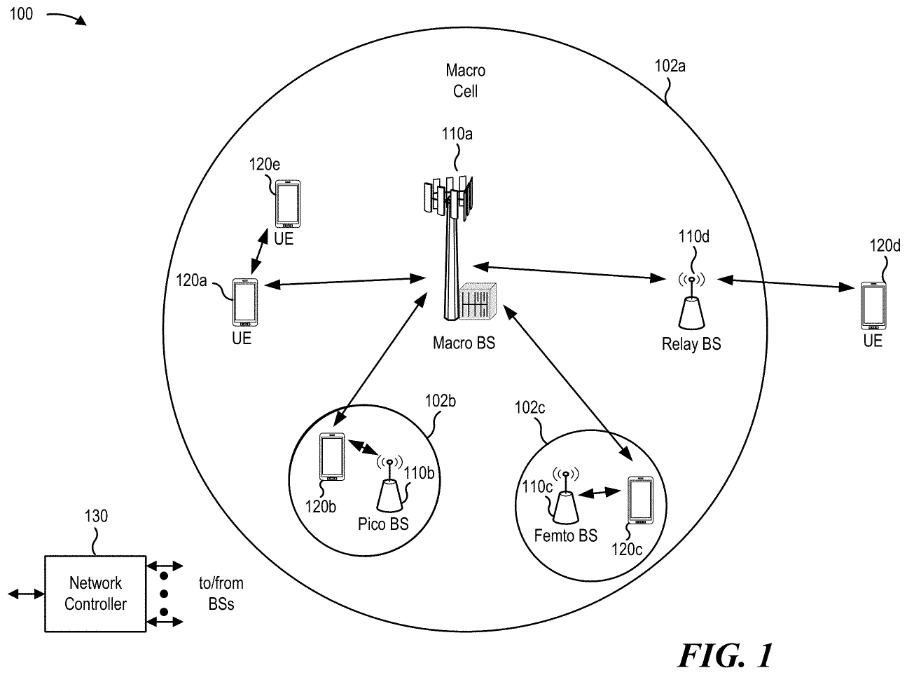

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “TRP,” “AP,” “node B,” “5G NB,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in the wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. The network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110.

As indicated above, FIG. 1 is provided merely as an example. Other examples may differ from what is described with regard to FIG. 1.

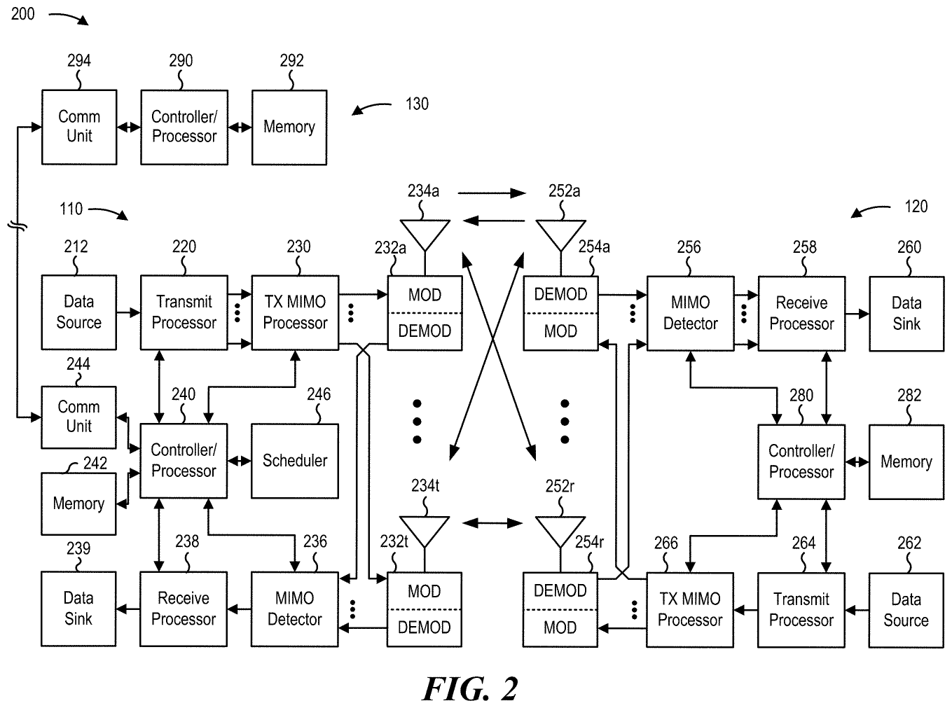

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MC S(s) selected for the UE, and provide data symbols for all UEs. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the network controller 130 via the communications unit 244. The network controller 130 may include a communications unit 294, a controller/processor 290, and a memory 292.

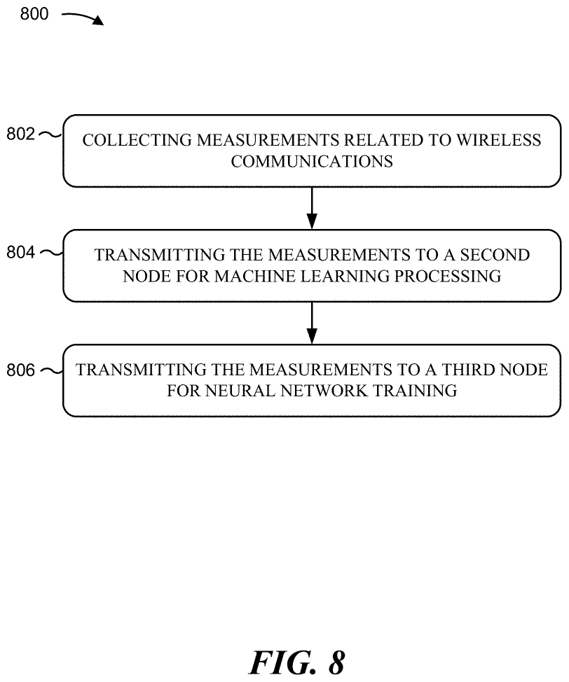

The controller/processor 240 of the base station 110, the controller/processor 280 of the UE 120, the controller/processor 290 of the network controller 130 and/or any other component(s) of FIG. 2 may perform one or more techniques associated with distributed machine learning, as described in more detail elsewhere. For example, the controller/processor 240 of the base station 110, the controller/processor 280 of the UE 120, the controller/processor 290 of the network controller 130 and/or any other component(s) of FIG. 2 may perform or direct operations of, for example, the processes of FIGS. 8-10 and/or other processes as described. Memories 242 and 282 may store data and program codes for the base station 110 and UE 120, respectively. A scheduler 246 may schedule UEs for data transmission on the downlink and/or uplink.

In some aspects, the UE 120 may include means for collecting, means for transmitting, means for receiving, means for processing, means for forwarding, means for reporting, means for configuring, and means for executing. Such means may include one or more components of the UE 120, base station 110, or network controller 130 described in connection with FIG. 2.

As indicated above, FIG. 2 is provided merely as an example. Other examples may differ from what is described with regard to FIG. 2.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

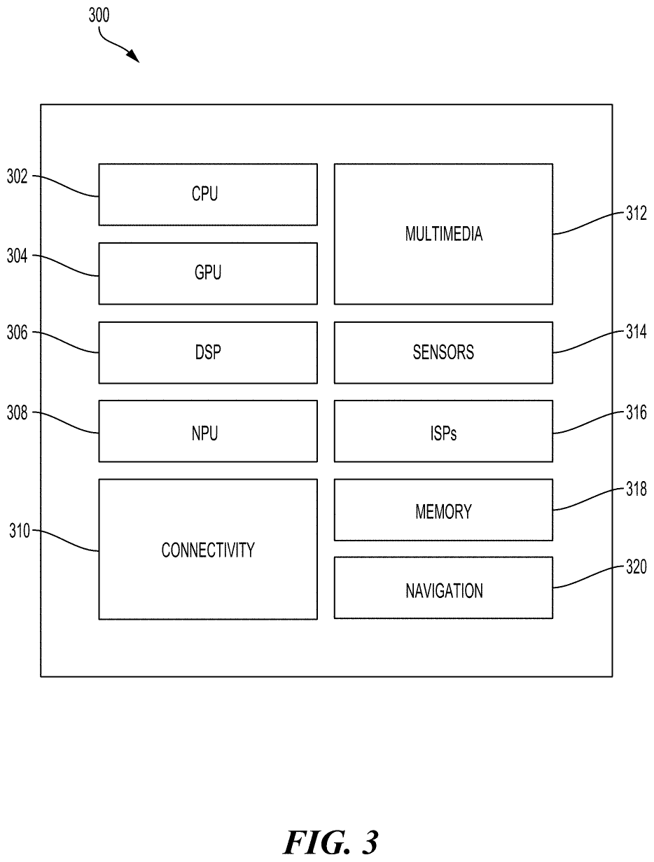

FIG. 3 illustrates an example implementation of a system-on-a-chip (SOC) 300, which may include a central processing unit (CPU) 302 or a multi-core CPU with an application to control machine learning algorithms, in accordance with certain aspects of the present disclosure. The SOC 300 may be included in the base station 110 or UE 120. Variables (e.g., neural signals and synaptic weights), system parameters associated with a computational device (e.g., neural network with weights), delays, frequency bin information, and task information may be stored in a memory block associated with a neural processing unit (NPU) 308, in a memory block associated with a CPU 302, in a memory block associated with a graphics processing unit (GPU) 304, in a memory block associated with a digital signal processor (DSP) 306, in a memory block 318, or may be distributed across multiple blocks. Instructions executed at the CPU 302 may be loaded from a program memory associated with the CPU 302 or may be loaded from a memory block 318.

The SOC 300 may also include additional processing blocks tailored to specific functions, such as a GPU 304, a DSP 306, a connectivity block 310, which may include fifth generation (5G) connectivity, fourth generation long term evolution (4G LTE) connectivity, Wi-Fi connectivity, USB connectivity, Bluetooth connectivity, and the like, and a multimedia processor 312 that may, for example, detect and recognize gestures. In one implementation, the NPU is implemented in the CPU, DSP, and/or GPU. The SOC 300 may also include a sensor processor 314, image signal processors (ISPs) 316, and/or navigation module 320, which may include a global positioning system.

The SOC 300 may be based on an ARM instruction set. In an aspect of the present disclosure, the instructions loaded into the general-purpose processor 302 may comprise code to collect, transmit, receive, process, forward, report, configure, execute, and report.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

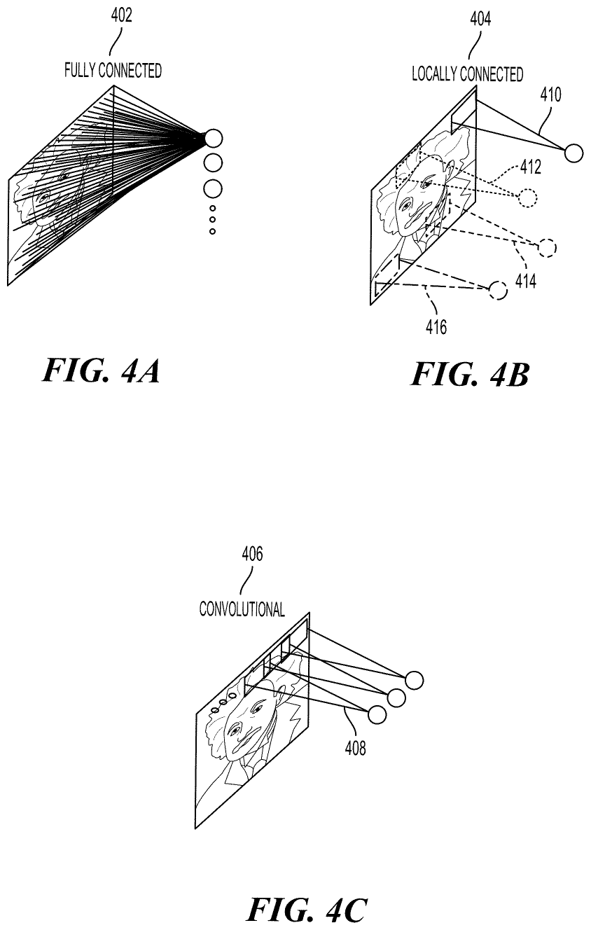

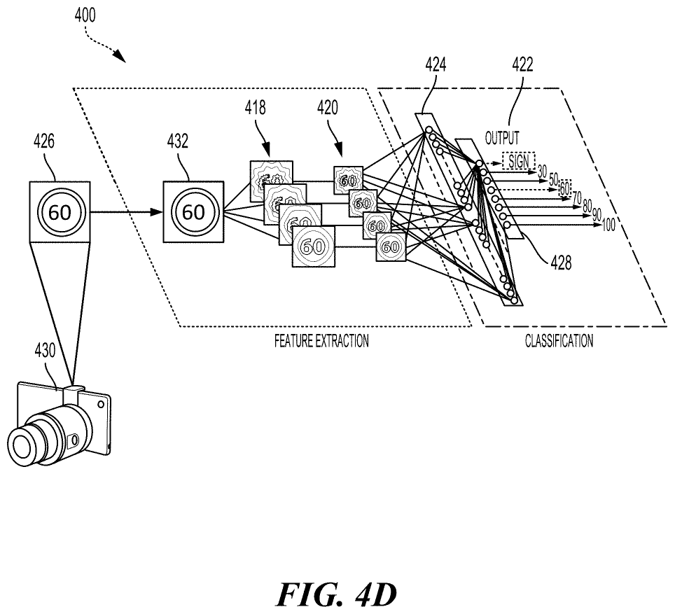

The connections between layers of a neural network may be fully connected or locally connected. FIG. 4A illustrates an example of a fully connected neural network 402. In a fully connected neural network 402, a neuron in a first layer may communicate its output to every neuron in a second layer, so that each neuron in the second layer will receive input from every neuron in the first layer. FIG. 4B illustrates an example of a locally connected neural network 404. In a locally connected neural network 404, a neuron in a first layer may be connected to a limited number of neurons in the second layer. More generally, a locally connected layer of the locally connected neural network 404 may be configured so that each neuron in a layer will have the same or a similar connectivity pattern, but with connections strengths that may have different values (e.g., 410, 412, 414, and 416). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 4C illustrates an example of a convolutional neural network 406. The convolutional neural network 406 may be configured such that the connection strengths associated with the inputs for each neuron in the second layer are shared (e.g., 408). Convolutional neural networks may be well suited to problems in which the spatial location of inputs is meaningful.

One type of convolutional neural network is a deep convolutional network (DCN). FIG. 4D illustrates a detailed example of a DCN 400 designed to recognize visual features from an image 426 input from an image capturing device 430, such as a car-mounted camera. The DCN 400 of the current example may be trained to identify traffic signs and a number provided on the traffic sign. Of course, the DCN 400 may be trained for other tasks, such as identifying lane markings or identifying traffic lights.

The DCN 400 may be trained with supervised learning. During training, the DCN 400 may be presented with an image, such as the image 426 of a speed limit sign, and a forward pass may then be computed to produce an output 422. The DCN 400 may include a feature extraction section and a classification section. Upon receiving the image 426, a convolutional layer 432 may apply convolutional kernels (not shown) to the image 426 to generate a first set of feature maps 418. As an example, the convolutional kernel for the convolutional layer 432 may be a 5×5 kernel that generates 28×28 feature maps. In the present example, because four different feature maps are generated in the first set of feature maps 418, four different convolutional kernels were applied to the image 426 at the convolutional layer 432. The convolutional kernels may also be referred to as filters or convolutional filters.

The first set of feature maps 418 may be subsampled by a max pooling layer (not shown) to generate a second set of feature maps 420. The max pooling layer reduces the size of the first set of feature maps 418. That is, a size of the second set of feature maps 420, such as 14×14, is less than the size of the first set of feature maps 418, such as 28×28. The reduced size provides similar information to a subsequent layer while reducing memory consumption. The second set of feature maps 420 may be further convolved via one or more subsequent convolutional layers (not shown) to generate one or more subsequent sets of feature maps (not shown).

In the example of FIG. 4D, the second set of feature maps 420 is convolved to generate a first feature vector 424. Furthermore, the first feature vector 424 is further convolved to generate a second feature vector 428. Each feature of the second feature vector 428 may include a number that corresponds to a possible feature of the image 426, such as “sign,” “60,” and “100.” A softmax function (not shown) may convert the numbers in the second feature vector 428 to a probability. As such, an output 422 of the DCN 400 is a probability of the image 426 including one or more features.

In the present example, the probabilities in the output 422 for “sign” and “60” are higher than the probabilities of the others of the output 422, such as “30,” “40,” “50,” “70,” “80,” “90,” and “100”. Before training, the output 422 produced by the DCN 400 is likely to be incorrect. Thus, an error may be calculated between the output 422 and a target output. The target output is the ground truth of the image 426 (e.g., “sign” and “60”). The weights of the DCN 400 may then be adjusted so the output 422 of the DCN 400 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images (e.g., the speed limit sign of the image 426) and a forward pass through the network may yield an output 422 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

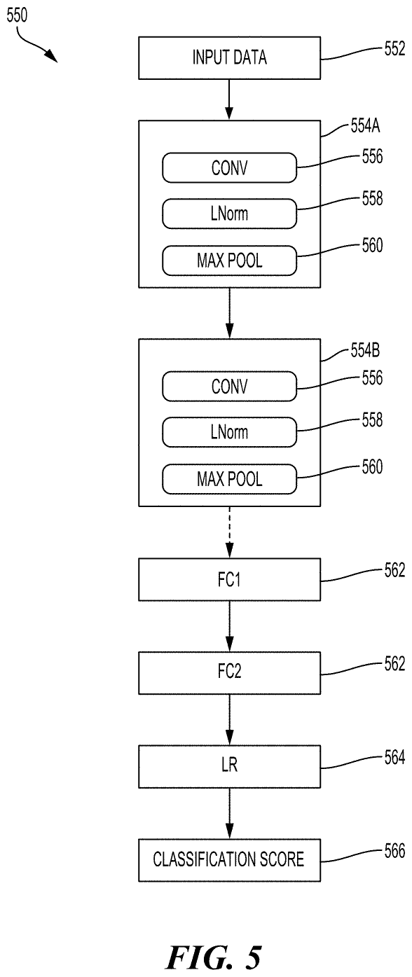

FIG. 5 is a block diagram illustrating a deep convolutional network 550. The deep convolutional network 550 may include multiple different types of layers based on connectivity and weight sharing. As shown in FIG. 5, the deep convolutional network 550 includes the convolution blocks 554A, 554B. Each of the convolution blocks 554A, 554B may be configured with a convolution layer (CONV) 356, a normalization layer (LNorm) 558, and a max pooling layer (MAX POOL) 560.

The convolution layers 556 may include one or more convolutional filters, which may be applied to the input data to generate a feature map. Although only two of the convolution blocks 554A, 554B are shown, the present disclosure is not so limiting, and instead, any number of the convolution blocks 554A, 554B may be included in the deep convolutional network 550 according to design preference. The normalization layer 558 may normalize the output of the convolution filters. For example, the normalization layer 558 may provide whitening or lateral inhibition. The max pooling layer 560 may provide down sampling aggregation over space for local invariance and dimensionality reduction.

The parallel filter banks, for example, of a deep convolutional network may be loaded on a CPU 302 or GPU 304 of an SOC 300 to achieve high performance and low power consumption. In alternative embodiments, the parallel filter banks may be loaded on the DSP 306 or an ISP 316 of an SOC 300. In addition, the deep convolutional network 550 may access other processing blocks that may be present on the SOC 300, such as sensor processor 314 and navigation module 320, dedicated, respectively, to sensors and navigation.

The deep convolutional network 550 may also include one or more fully connected layers 562 (FC1 and FC2). The deep convolutional network 550 may further include a logistic regression (LR) layer 564. Between each layer 556, 558, 560, 562, 564 of the deep convolutional network 550 are weights (not shown) that are to be updated. The output of each of the layers (e.g., 556, 558, 560, 562, 564) may serve as an input of a succeeding one of the layers (e.g., 556, 558, 560, 562, 564) in the deep convolutional network 550 to learn hierarchical feature representations from input data 552 (e.g., images, audio, video, sensor data and/or other input data) supplied at the first of the convolution blocks 554A. The output of the deep convolutional network 550 is a classification score 566 for the input data 552. The classification score 566 may be a set of probabilities, where each probability is the probability of the input data, including a feature from a set of features.

As indicated above, FIGS. 3-5 are provided as examples. Other examples may differ from what is described with respect to FIGS. 3-5.

Machine learning (ML) algorithms can assist with and improve cellular network performance. Machine learning algorithms, including a neural network based algorithm, can be implemented at a single node, such as a user equipment (UE) 120, base station 110 (e.g., next generation node-B (gNB)), or a central node, such as the network controller 130. Machine learning algorithms can also be implemented at a central server, such as a third party server, for example, a Google server that operates and/or maintains a neural network on behalf of users. Machine learning algorithms may also be distributed over multiple nodes. Machine learning algorithms may exist in different layers of a node or across nodes.

Machine learning algorithms may assist with different functions and/or modules, and interact with different layers, such as a physical layer (PHY), medium access control layer (MAC), or upper layers. For example, a machine learning module for decoding, such as low density parity check code (LDPC) decoding, may operate with the physical layer (PHY). A machine learning module for channel-state information (CSI) prediction or transmission configuration indication (TCI) selection or beam selection involves the PHY and MAC layers. A machine learning module for multi-user (MU) scheduling at the base station may request feedback from the UE. The machine learning module may account for package latency and packet priority based on the feedback. Additionally, the machine learning module may involve the PHY, MAC, and upper layers.

Machine learning algorithms may specify various machine learning related data to transfer between different layers or between different nodes. An example of a node is a base station (e.g., gNB), a UE, a chip of the UE or base station, a central controller of the network, or a server. An example of data being transferred includes training data collected from other nodes. In another example, the data exchange is for measurement data collected as input for machine learning modules. Also, machine learning model parameters may be transferred and/or updated, such as with deep learning scenarios. Intermediate data (e.g., gradient descent backpropagation data for a distributed algorithm) can be transferred, as can capability signaling and/or various reports between the base station and UEs. Another example of data transferred between different layers or different nodes includes UE feedback on model accuracy.

Machine learning may be applied at different nodes for different functions with a variety of data flows. According to aspects of the present disclosure, an architecture is specified to handle various machine learning modules and the data that is transferred between nodes and layers in wireless networks. A software component (or components) in the application layer of a communication protocol stack may control various machine learning modules and data flows. The software may be distributed among UEs, base stations, central nodes, and online servers, such as third party software provider servers.

In one aspect, the software controls multiple machine learning modules in a node. Different nodes may implement different machine learning modules based on capability. For example, a UE with higher computation capability may have more machine learning modules implemented than a lower cost UE.

In other aspects, the software controls data transfer flow between different layers and different nodes. For example, the software may collect measurement data from lower layers (e.g., PHY and MAC layers in a node) and the software may send the data to another node. In this example, the software transfers data from layer to layer and also to different nodes. For example, the data collected from the PHY layer may be first collected to the application layer by the software, packed in a certain format defined by the software, and sent to a certain port in the application layer of another node corresponding to the software.

In still other aspects, the software trains and runs the machine learning modules at different nodes. The training may be online or offline training. Machine learning modules, such as a neural network, may run at the server or run locally, for example at a local GPU (graphics processing unit) or NPU (neural processing unit) of the UE or base station.

In yet other aspects, the software controls how different (machine learning or non-machine learning) modules function at different nodes based on the output of the machine learning modules. For example, the machine learning algorithm may tell a UE to choose one beam for communication. The machine learning module notifies the decision to the MAC layer. The MAC layer schedules the beam and triggers a radio frequency (RF) module in the PHY layer to use that beam for communication. In another example, a reinforcement learning module selects parameters or a scheme of another machine learning module.

In further aspects, the software controls parameter updates and algorithm changes of the machine learning modules. For online training, for example, from time to time, the module may specify parameter updates. In another example, the best beam may be selected. The best beam is location specific. Thus, the UE's neural network parameters for CSI and beam prediction may only apply for a certain region. In this case, when a UE moves outside the region, the software triggers an update of the neural network parameters to help obtain the best beam for communications.

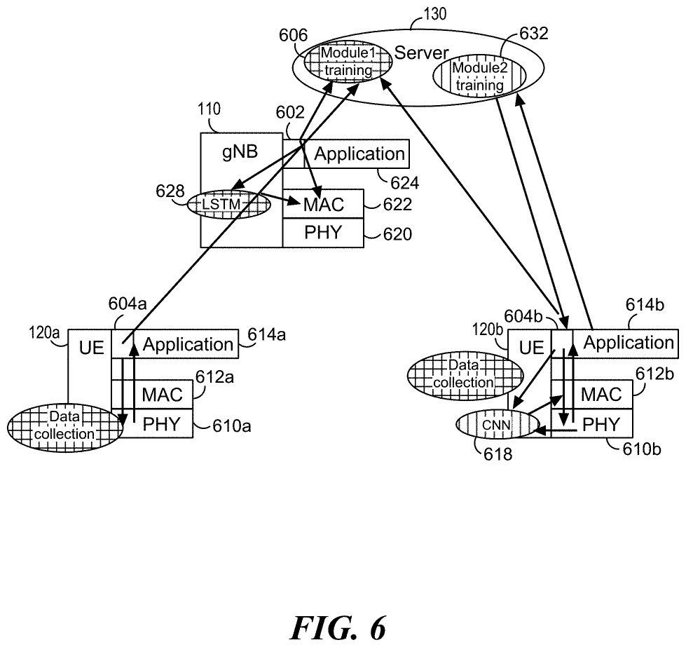

Some examples of application control will now be explained with reference to FIG. 6. FIG. 6 is a diagram illustrating an example distributed architecture for controlling machine learning modules, in accordance with various aspects of the present disclosure. In a first example, the software controls machine learning module 1, which is distributed as software 602 in the base station 110 (e.g., gNB), software 604a, 604b in the UEs 120a, 120b, and software 606 in the server 130. Each of the UEs 120a, 120b includes a PHY layer 610a, 610b, a MAC layer 612a, 612b, and an application layer 614a, 614b. The gNB 110 includes a PHY layer 620, a MAC layer 622, and an application layer 624.

In the example of FIG. 6, the machine learning module 1 is for base station side beam prediction based on UE measurements. The UE side software 604a, 604b collects UE channel measurement from its PHY layers 610a, 610b and packs the PHY layer measurement data into UE application layers 614a, 614b. The UE side software 604a, 604b then sends the data to the base station side software 602 and the server side software 606, which reside in an application layer 624 (application layer not shown for the server side software 606), for example. The base station side software 602 receives the UE data and passes the measurements as input to a neural network 628, which may be a long short term memory (LSTM) neural network. The base station 110 forward propagates the data through the neural network 628 and passes the output of the neural network 628 to a beam selection module (not shown). The output of the neural network 628 changes parameters of the beam selection module accordingly. The base station 110 also receives a neural network parameter update from the server 130. The servers side software 606 receives the UE side measurement data, trains the server neural network (not shown), and sends a neural network update to the base station side software 628.

In another example of software control shown in FIG. 6, machine learning module 2 includes UE side software 604b and server side software 632 for LDPC decoding. The UE side software 604b and server side software 632 reside in an application layer 614b (application layer not shown for the server side software 606). The UE side software 604b for the machine learning module 2 reports a UE capability to the server 130. The server 130 sends the convolutional neural network (CNN) configuration to the UE 120b based on UE capability reporting. The UE side software 604b configures CNN parameters based on server input. The UE side software 604b collects a package to decode from a demapper in the baseband chip, and sends the package to the GPU, where a CNN 618 executes. The UE 120b sends the output of the CNN 618 to the MAC layer 612b, and reports any decoding error to the server 130. The server side software 632 also receives the UE report of decoding error and sends updates for the CNN 618 to the UE 120b.

Although not shown in FIG. 6, machine learning module 3 helps with UE side receive beam prediction. Machine learning module 3 specifies the UE 120, base station 110, and server 130 applications to exchange data. The neural network algorithm is run at the UE 120. Machine learning module 4 (not shown) can help with UE side channel estimation. The machine learning module 4 operates on the UE 120 and server 130. The application controls the algorithm running at the UE 120. The server 130 may update the UE 120, as desired.

Machine learning module 5 (not shown) can assist with UE side power amplifier (PA) nonlinearity correction for uplink communications. The machine learning module 5 is similar to the machine learning modules 2 or 4. Machine learning module 6 (not shown) is for UE and base station side traffic prediction. The machine learning module 6 involves application layer, transportation layer, MAC layer, and PHY layer data exchanges at both the UE 120 and base station 110. The machine learning module 6 can include a server side application to update the model online.

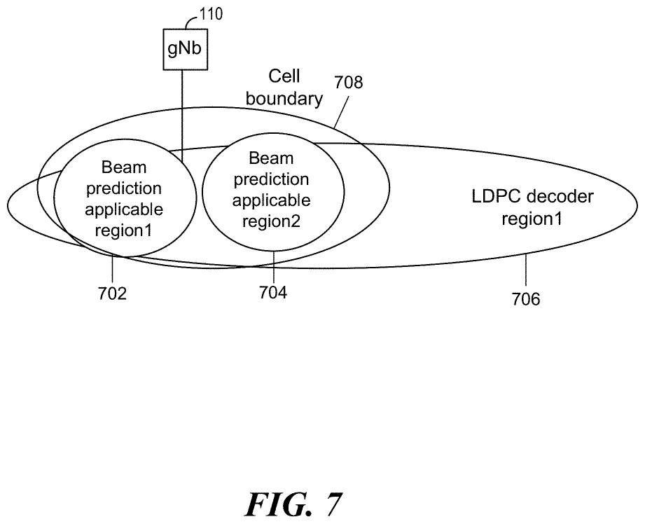

Different modules may have different applicable regions or different time scales to control updating based on their usage. For example, beam and CSI prediction modules may be specific to the environment. FIG. 7 is a diagram illustrating example regions associated with machine learning modules, in accordance with various aspects of the present disclosure. As seen in FIG. 7, beam prediction modules may be specific to the environment. Therefore, the choice of parameters of machine learning algorithms or the choice of machine learning algorithms in the machine learning module is specific to the location or time. For instance, if a UE (not shown) moves outside certain beam prediction applicable regions 702, 704 (e.g., which are a fraction of a cell of the base station 110), the parameters for such a neural network should change. Some modules may apply to a much larger area, such as an LDPC decoder region 706. For example, LDPC decoding may apply anywhere, even outside a cell boundary 708. The size and/or area of the applicable region may be module specific even for the same type of module. An applicable region boundary may or may not coincide with a cell boundary.

Similarly, a time scale to update parameters may differ from module to module. A module to predict phase errors due to phase noise (PN) may only adjust every day. A module to predict small scale fading may adjust every few minutes, as UE movement speed changes.

FIG. 8 is a diagram illustrating an example process 800 performed, for example, by a first node, in accordance with various aspects of the present disclosure. The example process 800 is an example process for controlling machine learning (ML) assisted communications networks.

As shown in FIG. 8, in some aspects, the process 800 may include collecting measurements related to wireless communications (block 802). For example, the first node (e.g., using the antenna 252, 234, DEMOD 254, 232, MIMO detector 256, 236, receive processor 258, 238, controller/processor 280, 240, memory 282, 242 and or the like) can collect the measurements for base station side beam prediction based on UE measurements. The UE side software may collect UE channel measurements from its PHY layer and packs the PHY layer measurement data into the UE application layer.

As shown in FIG. 8, in some aspects, the process 800 may include transmitting the measurements to a second node for machine learning processing (block 804). For example, the first node (e.g., using the antenna 252, 234, MOD 254, 232, TX processor 266, 230, controller/processor 280, 240, memory 282, 242, and or the like) can transmit the measurements to the base station side software.

As shown in FIG. 8, in some aspects, the process 800 may include transmitting the measurements to a third node for neural network training (block 806). For example, the first node (e.g., using the antenna 252, 234, MOD 254, 232, TX processor 266, 230, controller/processor 280, memory 282, and or the like) can transmit the measurements to the server side software.

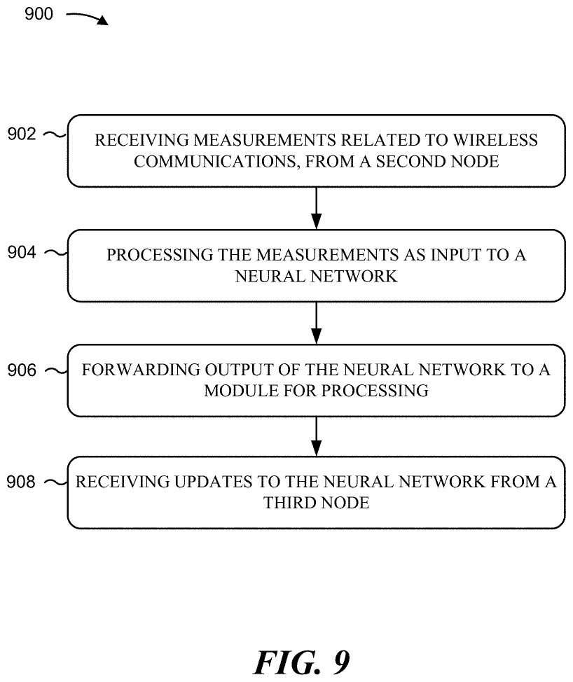

FIG. 9 is a diagram illustrating an example process 900 performed, for example, by a first node, in accordance with various aspects of the present disclosure. The example process 900 is an example of controlling machine learning (ML) assisted communications networks.

As shown in FIG. 9, in some aspects, the process 900 may include receiving measurements related to wireless communications, from a second node (block 902). For example, the first node (e.g., using the antenna 252, 234, DEMOD 254, 232, MIMO detector 256, 236, receive processor 258, 238, controller/processor 280, 240, memory 282, 242, and or the like) can receive the measurements. In some instances when the first node is a base station, the measurements may be UE channel measurements.

As shown in FIG. 9, in some aspects, the process 900 may include processing the measurements as input to a neural network (block 904). For example, the first node (e.g., using the controller/processor 280, 240, memory 282, 242, and or the like) can process the measurements as input to a neural network. In case the first node is a base station, the base station side software may receive the UE data and pass the measurements as input to a neural network, such as a long short term memory (LSTM) neural network.

As shown in FIG. 9, in some aspects, the process 900 may include forwarding output of the neural network to a module for processing (block 906). For example, the first node (e.g., using the antenna 252, 234, MOD 254, 232, TX processor 266, 230, controller/processor 280, 240, memory 282, 242 and or the like) can forward the output. Again, in the case of a base station, after forward propagating the data through the neural network, the base station may pass the output of the neural network to a beam selection module. The output of the neural network changes parameter of the beam selection module accordingly.

As shown in FIG. 9, in some aspects, the process 900 may include receiving updates to the neural network from a third node (block 908). For example, the first node (e.g., using the antenna 252, 234, DEMOD 254, 232, MIMO detector 256, 236, receive processor 258, 238, controller/processor 280, 240, memory 282, 242, and or the like) can receive the updates. In the case of a base station operating as the first node, the base station may receive a neural network parameter update from the server. In this case, the servers side software receives the UE side measurement data, trains a server neural network, and sends a neural network update to the base station side software based on training the server neural network.

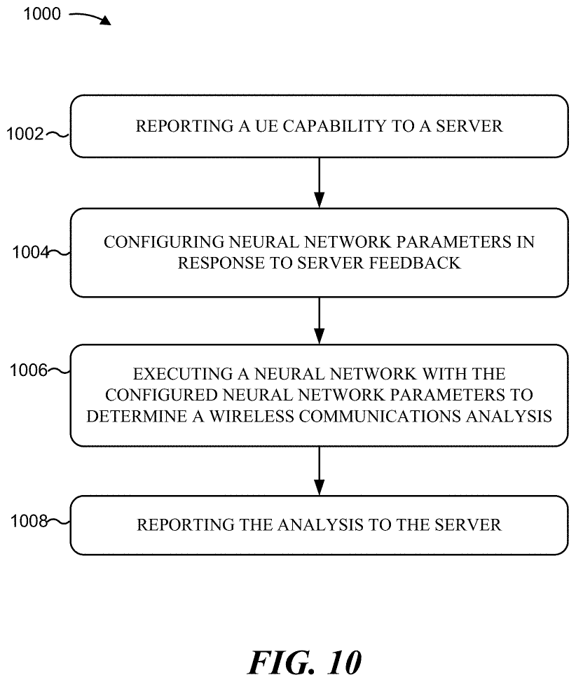

FIG. 10 is a diagram illustrating an example process 1000 performed, for example, by a UE, in accordance with various aspects of the present disclosure. The example process 1000 is an example of controlling machine learning (ML) assisted communications networks.

As shown in FIG. 10, in some aspects, the process 1000 may include reporting a UE capability to a server (block 1002). For example, the UE (e.g., using the antenna 252, MOD 254, TX MIMO processor 266, controller/processor 280, memory 282, and or the like) may report a UE capability to a server. In an LDPC decoding example, the UE side software may report a UE capability to the server, such as a UE processing capability.

As shown in FIG. 10, in some aspects, the process 1000 may include configuring neural network parameters in response to server feedback (block 1004). For example, the UE (e.g., using the antenna 252, DEMOD 254, MIMO detector 256, receive processor 258, controller/processor 280, memory 282, and or the like) may configure neural network parameters in response to server feedback. In the LDPC example, the UE side software may configure convolutional neural network (CNN) parameters based on a server response to the UE capability report.

As shown in FIG. 10, in some aspects, the process 1000 may include executing a neural network with the configured neural network parameters to determine a wireless communications analysis (block 1006). For example, the UE (e.g., using the antenna 252, MOD 254, TX MIMO processor 266, DEMOD 254, MIMO detector 256, receive processor 258, controller/processor 280, memory 282, and or the like) may execute the neural network with the configured neural network parameters. In the LDPC example, the UE side software collects a package to decode from a demapper in the baseband chip, and sends the package to the GPU, where a CNN executes.

As shown in FIG. 10, in some aspects, the process 1000 may include reporting the analysis to the server (block 1008). For example, the UE (e.g., using the antenna 252, MOD 254, TX MIMO processor 266, controller/processor 280, memory 282, and or the like) may report the analysis to the server. The UE may send the output of the CNN to the MAC layer, and report any decoding error to the server. The server side software receives the UE report of decoding error and may send updates for the neural network to the UE.

Implementation examples are described in the following numbered clauses.

1. An apparatus for wireless communications, comprising:

a first component within an application layer of a communication protocol stack and configured to control a plurality of machine learning modules in different nodes; and

a second component within the application layer and configured to control data flow between the different nodes.

2. The apparatus of clause 1, in which the data flow is between the different nodes within the application layer.
3. The apparatus of clause 1 or 2, further comprising a communications component configured to cooperate with a software application in a different node to control at least some of the plurality of machine learning modules in the different node.
4. The apparatus of any of the preceding clauses, further comprising a third component configured to control data flow between different layers of the apparatus.
5. The apparatus of any of the preceding clauses, further comprising a training component configured to train machine learning modules for the different nodes.
6. The apparatus of any of the preceding clauses, further comprising an executing component configured to execute machine learning modules of the different nodes.
7. The apparatus of any of the preceding clauses, in which the first component is configured to control based on an output of at least one of the machine learning modules.
8. The apparatus of any of the preceding clauses, in which an output of at least one of the plurality of machine learning modules controls another module.
9. The apparatus of any of the preceding clauses, in which the other module comprises a radio frequency (RF) module for beam selection.
10. The apparatus of any of the preceding clauses, further comprising an updating component configured to update parameters and/or algorithms for at least one of the plurality of machine learning modules.
11. The apparatus of any of the preceding clauses, in which the updating component is configured to update in response to a user equipment (UE) moving outside a particular region.
12. The apparatus of any of the proceeding clauses, in which different machine learning modules are associated with different regions.
13. The apparatus of any of the preceding clauses, in which the updating component is configured to update in response to a time duration expiring, in which different machine learning modules are associated with different time durations.
14. The apparatus of any of the preceding clauses, in which the different nodes comprise at least one of a base station, a user equipment (UE), a chip of the base station, a chip of the UE, a central controller, or a server.
15. A method of wireless communications, by a first node, comprising:

collecting measurements related to wireless communications;

transmitting the measurements to a second node for machine learning processing; and

transmitting the measurements to a third node for neural network training.

16. The method of clause 15, in which the first node comprises a user equipment (UE), the second node comprises a base station, and the third node comprises a server.
17. The method of clause 15, in which the first node comprises a base station, the second node comprises a user equipment (UE), and the third node comprises a server.
18. The method of any of the clauses 15-17, in which the machine learning processing is for beam prediction, channel estimation, power amplifier nonlinearity correction, or traffic prediction.
19. A method of wireless communications, by a first node, comprising:

receiving measurements related to wireless communications, from a second node;

processing the measurements as input to a neural network;

forwarding output of the neural network to a module for processing; and

receiving updates to the neural network from a third node.

20. The method of clause 19, in which the first node comprises a user equipment (UE), the second node comprises a base station, and the third node comprises a server.
21. The method of clause 19, in which the first node comprises a base station, the second node comprises a user equipment (UE), and the third node comprises a server.
22. The method of any of the clauses 19-21, in which the processing is for beam prediction, channel estimation, power amplifier nonlinearity correction, or traffic prediction.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. An apparatus for wireless communications, comprising:
a first component within an application layer of a communication protocol stack and configured to control a plurality of machine learning modules in different nodes; and
a second component within the application layer and configured to control data flow between the different nodes.

2. The apparatus of claim 1, in which the data flow is between the different nodes within the application layer.

3. The apparatus of claim 1, further comprising a communications component configured to cooperate with a software application in a different node to control at least some of the plurality of machine learning modules in the different node.

4. The apparatus of claim 1, further comprising a third component configured to control data flow between different layers of the apparatus.

5. The apparatus of claim 1, further comprising a training component configured to train machine learning modules for the different nodes.

6. The apparatus of claim 1, further comprising an executing component configured to execute machine learning modules of the different nodes.

7. The apparatus of claim 1, in which the first component is configured to control based on an output of at least one of the plurality of machine learning modules.

8. The apparatus of claim 1, in which an output of at least one of the machine learning modules controls another module.

9. The apparatus of claim 8, in which the other module comprises a radio frequency (RF) module for beam selection.

10. The apparatus of claim 1, further comprising an updating component configured to update parameters and/or algorithms for at least one of the plurality of machine learning modules.

11. The apparatus of claim 10, in which the updating component is configured to update in response to a user equipment (UE) moving outside a particular region.

12. The apparatus of claim 11, in which different machine learning modules are associated with different regions.

13. The apparatus of claim 10, in which the updating component is configured to update in response to a time duration expiring, in which different machine learning modules are associated with different time durations.

14. The apparatus of claim 1, in which the different nodes comprise at least one of a base station, a user equipment (UE), a chip of the base station, a chip of the UE, a central controller, or a server.

15. A method of wireless communications, by a first node, comprising:
collecting measurements related to wireless communications;
transmitting the measurements to a second node for machine learning processing; and
transmitting the measurements to a third node for neural network training.

16. The method of claim 15, in which the first node comprises a user equipment (UE), the second node comprises a base station, and the third node comprises a server.

17. The method of claim 15, in which the first node comprises a base station, the second node comprises a user equipment (UE), and the third node comprises a server.

18. The method of claim 15, in which the machine learning processing is for beam prediction, channel estimation, power amplifier nonlinearity correction, or traffic prediction.

19. A method of wireless communications, by a first node, comprising:
receiving measurements related to wireless communications, from a second node;
processing the measurements as input to a neural network;
forwarding output of the neural network to a module for processing; and
receiving updates to the neural network from a third node.

20. The method of claim 19, in which the first node comprises a user equipment (UE), the second node comprises a base station, and the third node comprises a server.

21. The method of claim 19, in which the first node comprises a base station, the second node comprises a user equipment (UE), and the third node comprises a server.

22. The method of claim 19, in which the processing is for beam prediction, channel estimation, power amplifier nonlinearity correction, or traffic prediction.

23. A method of wireless communications by a user equipment (UE), comprising:
reporting a UE capability to a server;
configuring neural network parameters in response to feedback from the server;
executing a neural network with the configured neural network parameters to determine a wireless communications analysis; and
reporting the wireless communications analysis to the server.

24. The method of claim 23, in which executing the neural network is for decoding or channel estimation.
